(19) United States
(12) Patent Application Publication
(10) Pub. No.: US 2013/0001489 A1
(43) Pub. Date: Jan. 3, 2013

(54) MANUAL CHAIN BLOCK

(75) Inventor: Kazumitsu Ishikawa, Nakakoma-gun (JP)

(73) Assignee: Kito Corporation, Yamanashi (JP)

(21) Appl. No.: 13/634,845

(22) PCT Filed: Mar. 16, 2011
(86) PCT No.: PCT/JP2011/057060

§ 371 Date: Sep. 13, 2012

(30) Foreign Application Priority Data
Mar. 25, 2010 (JP) 2010-069912

(51) Int. Cl. B66D 1/14; B66D 3/16; B66D 1/04

(52) U.S. Cl. 254/342

(57) ABSTRACT

Disclosed is a manual chain block that achieves a more compact overall device and also does not lose the strength of the device itself by means of the position of a reduction gear of a speed reduction mechanism section being able to be positioned closer to the center regardless of the bearing of a load sheave. In the manual chain block, a load sheave (12) is supported rotatably by a first and second primary frame (11a, 11b) by means of bearings (13a, 13b) with axle sections (12a, 12b) therebetween. A supplemental plate (30)—which forms, in the direction of thrust: a bearing hole (33) of an axle section (16br) of a first reduction gear (16b); and a drawn section (31)—is, in a manner so as to supplement the aforementioned first primary frame (11a), disposed at the periphery of the bearing (13a) that supports the axle section (12a) of the load sheave (12) at the first primary frame (11a).

### FIELD OF THE INVENTION

The present invention relates to a manual chain block, and in particular to a manual chain block in which an arrangement of a reduction gear mechanism is redesigned to achieve further size reduction and weight reduction while ensuring adequate strength.

### BACKGROUND ART

A manual chain block used for a load lifting operation has been conventionally known, which includes a chain block main body, an upper hook for suspending the chain block main body, a load chain looped around a load sheave of the chain block main body, a lower hook connected to a lower end of the load chain, and a hand chain looped around a hand wheel. The hand chain includes, for example, an endless chain, an endless belt or an endless rope, and has a function of transmitting operational force of an operator to the hand wheel. Similarly, the hand wheel is engaged with the endless chain, the endless belt or the endless rope to convert the operational force of the operator into rotational force.

An exemplary configuration of a manual chin block as described above is disclosed in JP 59-195193 U, for example.

As shown in FIG. 6, a manual chain block 1 has a pair of frames 2a and 2b opposed to each other with a predetermined spacing therebetween. Between these frames 2a and 2b, a base shaft 4 of a load sheave 3 is rotatably supported by bearings 4B. A drive shaft 5 is rotatably supported in a center hole 4a of the base shaft 4. A reduction gear mechanism 6 is interposed between the drive shaft 5 and the load sheave 3 such that rotational power of the drive shaft 5 is transmitted to the load sheave 3 at a decreased speed, in order to wind the load chain up and down.

The reduction gear mechanism 6 includes a pinion gear 6a provided at one end of the drive shaft 5, two first reduction gears 6b and 6b which mesh with the pinion gear 6a, second reduction gears 6d and 6d provided on gear shafts 6c and 6c of the first reduction gears 6b and 6b, and a load gear 6e which meshes with the second reduction gears 6d and 6d. In this case, in order to support the gear shafts 6c and 6c of the first reduction gears 6b and 6b, a bearing 6f is provided on the frame 2a at a position radially outside of the bearing 4B for supporting the base shaft 4 of the load sheave 3.

The drive shaft 5 has a threaded portion 7 on the other end of the drive shaft 5 opposite to the pinion gear 6a. A mechanical brake 9 with a hand wheel 8 is screwed onto the threaded portion 7.

### SUMMARY OF THE INVENTION

### Problem to be Solved by the Invention

However, in the manual chain block as described above, the distances between axes of the first reduction gears 6b and 6b and of the pinion gear 6a, and between axes of the second reduction gears 6d and 6d and the load gear 6e are large, resulting in an increased diameter of each gear. In addition, because of the bearings 4B for supporting the base shaft 4 of the load sheave 3 and of the bearing 6f for supporting the gear shafts 6c and 6c of the first reduction gears 6b and 6b, the shaft of each reduction gear is prevented from being positioned closer to a central axis of the drive shaft 5. This prevents size reduction of the manual chain block 1.

The present invention is proposed to overcome the above-described problem, and has the object of providing a manual chain block that allows a reduction gear of a reduction gear mechanism to be positioned on an inner side of the apparatus, irrespective of an outer shape of a bearing of a load sheave, in order to achieve size reduction of the overall apparatus without impairing the strength of the apparatus.

### Means for Solving the Problem

In order to achieve the above-described object, a manual chain block is provided as defined in Claim 1, the manual chain block including a drive shaft capable of rotating in response to a manual operational force, and a load sheave around which a load chain is looped, the load sheave being mounted coaxially to the drive shaft, supported together with the drive shaft on a frame via a bearing and coupled to the drive shaft so that mechanical power is transmitted therebetween, via a reduction gear mechanism, wherein the reduction gear mechanism includes a pinion gear provided on the drive shaft, reduction gears which mesh with the pinion gear, and a load gear which is interlocked with the load sheave and meshes with the reduction gears, and wherein the manual chain block further includes an auxiliary plate mounted on a side surface of the frame and in the periphery of the bearing, the auxiliary plate including a stepped portion formed in a thrust direction of the bearing and having a bearing hole which serves as a bearing for the reduction gear.

With the above manual chain block, a conventional bearing for the reduction gears can be omitted. Therefore, even if the bearing for supporting the load sheave on the frame is a roller bearing having a large diameter, the shaft of the reduction gear can be positioned closer to the center despite the presence of such a bearing. This allows the reduction gear mechanism to occupy only a smaller space. The auxiliary plate can also bear force acting on the reduction gears and thrust force acting on the bearing for supporting the load sheave by means of the stepped portion of the auxiliary plate.

In accordance with the invention as defined in Claim 2, the auxiliary plate has a draw portion formed by drawing so as to be spaced apart over a predetermined distance from a surface of the frame on which the auxiliary plate is mounted, a center hole formed in a center of the draw portion, and a bearing hole formed in the vicinity of the center hole and projecting toward the surface of the frame on which the auxiliary plate is mounted, so as to serve as a bearing for the reduction gear.

With the above manual chain block, the shaft of the reduction gear is supported by the bearing hole projecting toward the surface of the frame onto which the auxiliary plate is mounted. This allows the auxiliary plate to be a thin plate made of steel, for example.

In accordance with the invention as defined in Claim 3, the bearing hole is formed in a tubular portion projecting toward the frame by means of burring.

With the above manual chain block, when the auxiliary plate is mounted onto the frame, the tubular portion defining the bearing hole abuts to the surface of the frame onto which the auxiliary plate is mounted, so that thrust force from the reduction gear acting on the bearing hole is transmitted to and is borne by the frame. Therefore, the thickness of the auxiliary plate can be reduced.

In accordance with the invention as defined in Claim 4, the manual chain block has a fixing hole for fixing the auxiliary plate by means of a rivet, the fixing hole being formed in the auxiliary plate in the vicinity of an outside of an outer edge of the draw portion.

With the above fixing hole, the auxiliary plate can be easily attached to the frame, while misalignment of the auxiliary plate is prevented.

In accordance with the invention as defined in Claim 5, the tubular portion of the bearing hole of the auxiliary plate situated closer to the center hole is positioned so as to come in contact with a side surface of the bearing.

With the above manual chain block, not only can the shaft of the reduction gear be positioned closer to the center, but force in a thrust direction acting on the bearing of the load sheave is borne by the tubular portion of the bearing hole of the auxiliary plate situated closer to the center. This eliminates a need for a thrust stop ring used for the bearing for supporting the load sheave.

In accordance with the present invention, by means of an auxiliary plate having a stepped portion and defining a bearing hole which substitutes an ordinary bearing, which is usually used, the ordinary bearing for the gear shaft can be dispensed with in order to form a reduction gear mechanism. As a result, irrespective of the bearing for the load sheave, the gear shaft of the reduction gear mechanism can be positioned closer to the center. Accordingly, the overall size of the apparatus can be further reduced. In addition, since the stepped portion can bear force in a thrust direction or the like, the auxiliary plate and the frame can be thinner.

### BRIEF DESCRIPTION OF THE DRAWINGS

FIG. 1 is a longitudinal sectional view showing a manual chain block according to a first embodiment of the present invention;

FIG. 2 is a transverse sectional view showing the manual chain block, taken along line A-A shown in FIG. 1;

FIG. 3 is a side view showing the manual chain block, seen from direction B shown in FIG. 1;

FIG. 4a is a plan view showing an arrangement of an assembly of a first main frame of the manual chain block shown in FIG. 1 and of an auxiliary plate mounted onto the first main frame;

FIG. 4b is a sectional view showing the first main frame and a holding plate, taken along line C-C shown in FIG. 4a;

FIG. 5 is a longitudinal sectional view showing a manual chain block according to a second embodiment of the present invention; and

FIG. 6 is a longitudinal sectional view showing an example of known manual chain block.

### EMBODIMENT FOR CARRYING OUT THE INVENTION

Various embodiments of a manual chain block according to the present invention will be described below with reference to appended drawings.

### First Embodiment

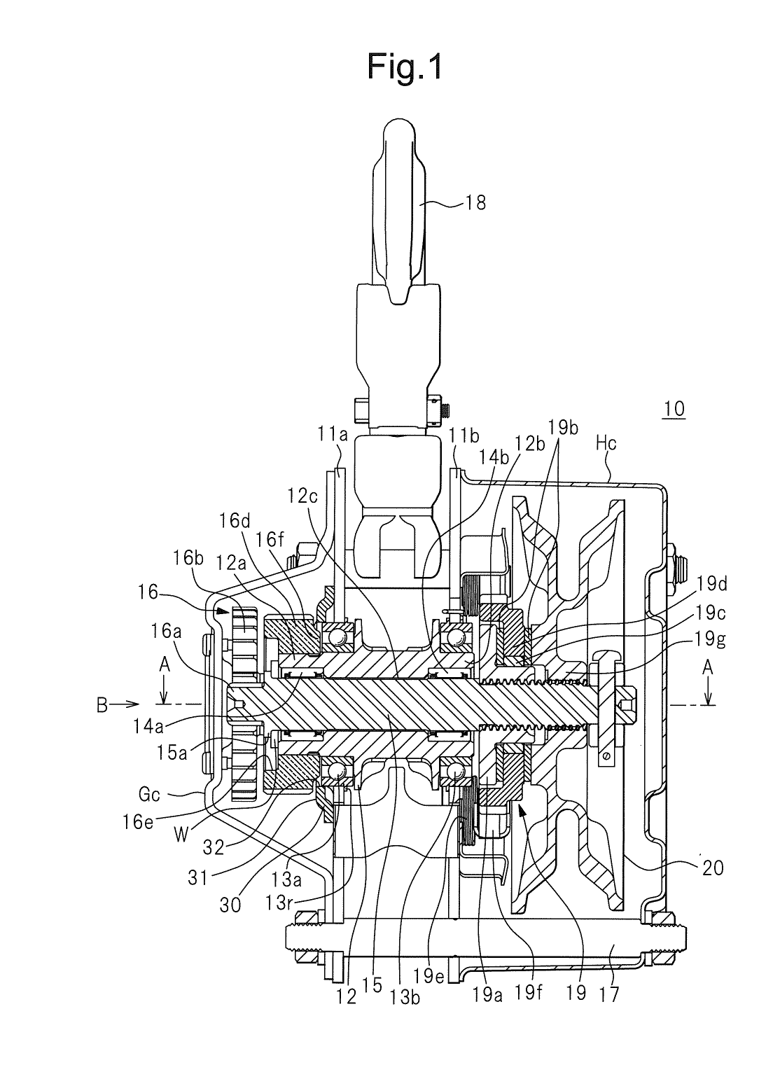

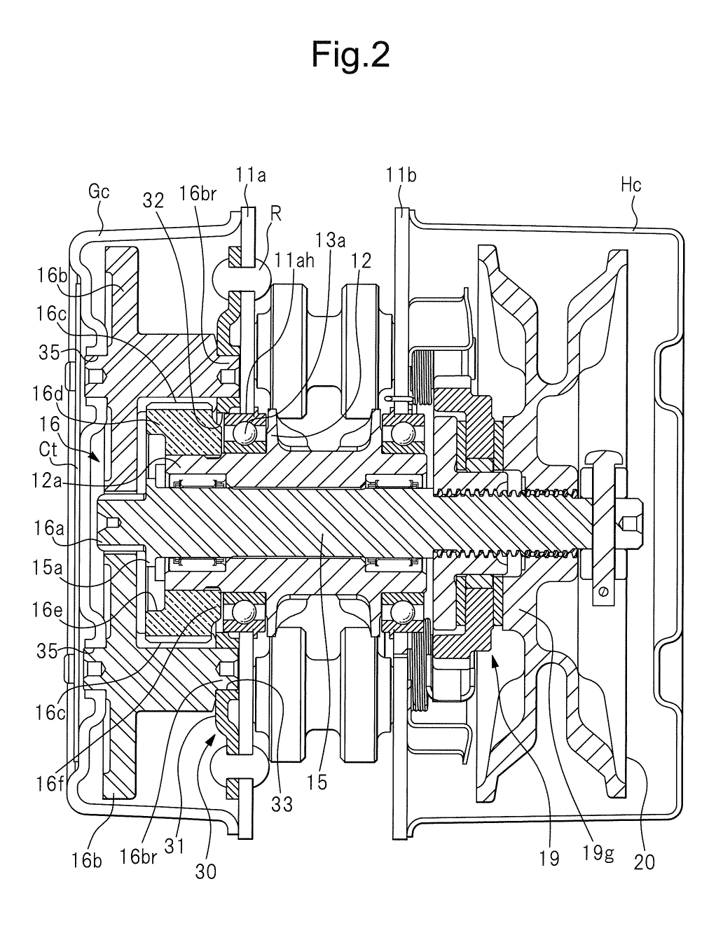

FIGS. 1 and 2 show a manual chain block 10 according to a first embodiment.

The manual chain block 10 includes a first and a second main frames 11a and 11b disposed opposite to each other at a predetermined distance, and a load sheave 12 rotatably supported on the first and the second main frames 11a and 11b with bearings (ball bearings) 13a and 13b interposed therebetween. The load sheave 12 is supported by the bearings 13a and 13b at shaft portions 12a and 12b.

In the manual chain block 10, a drive shaft 15 extends in a through-hole 12c extending through a central axis of the shaft portion 12a and 12b of the load sheave 12. The drive shaft 15 is supported so as to be rotatable relative to the load sheave 12 via needle bearings 14a and 14b.

A reduction gear mechanism 16 is interposed between the drive shaft 15 and the load sheave 12, and rotational power output of the drive shaft 15 is transmitted to the load sheave 12 at a decreased speed.

A gear cover Gc for housing the reduction gear mechanism 16 and a wheel cover Hc for housing a mechanical brake 19 and a hand wheel 20, which will be described below, are interconnected to each other and held by the first and the second main frames 11a and 11b by means of three stud bolts 17. Further, an upper hook 18 is pivotally attached to the first and the second main frames 11a and 11b by means of a shaft (not shown) fixed to an upper part of the first and the second main frames 11a and 11b.

In the drawing, the reduction gear mechanism 16 is situated at the end of the left side of the drive shaft 15 which projects from the shaft portion 12a of the load sheave 12 toward the left side of the first main frame 11a. On the other hand, a thread (multiple thread) with relatively large lead extends to an axial end of the drive shaft 15 at the end of the right side of the drive shaft 15 which projects from the shaft portion 12b of the load sheave 12 toward the right side of the second frame 11b. The mechanical brake 19 provided with a hand wheel 20 is attached to the axial end of the drive shaft 15.

The mechanical brake 19 includes a driven member 19a, a pair of brake members 19b and 19b interposed in the outer periphery of a boss portion of the driven member 19a, a ratchet gear 19d interposed between the brake members 19b and 19b via a bush 19c, a claw member 19f biased by a torsion spring 19e provided at the second main frame 11b so as to mesh with the ratchet gear 19d and prevent the ratchet gear 19d from rotating in a direction to wind down, and a drive member 19g integrally provided with a hand wheel 20 in the outer periphery thereof.

An endless chain (not shown) is looped around the hand wheel 20 for transmitting operational force by an operator to the hand wheel 20. When the hand wheel 20 undergoes positive rotation by a hand chain, the drive member 19g is moved on the multiple thread of the drive shaft 15 so as to be pressed against the brake member 19b of the mechanical brake 19, and the hand wheel 20 and the drive shaft 15 are coupled together so that mechanical power is transmitted therebetween. As a result, rotational power of the hand wheel 20 when winding up is transmitted to the drive shaft 15. On the other hand, when the hand wheel 20 undergoes reverse rotation, the drive member 19g releases the brake member 19b and the ratchet gear 19d which have been pressed against each other, terminating the braking action. As a result, the drive shaft 15 is able to rotate in the direction to wind down.

Next, the reduction gear mechanism 16 situated on the left end side of the drive shaft 15 will be described.

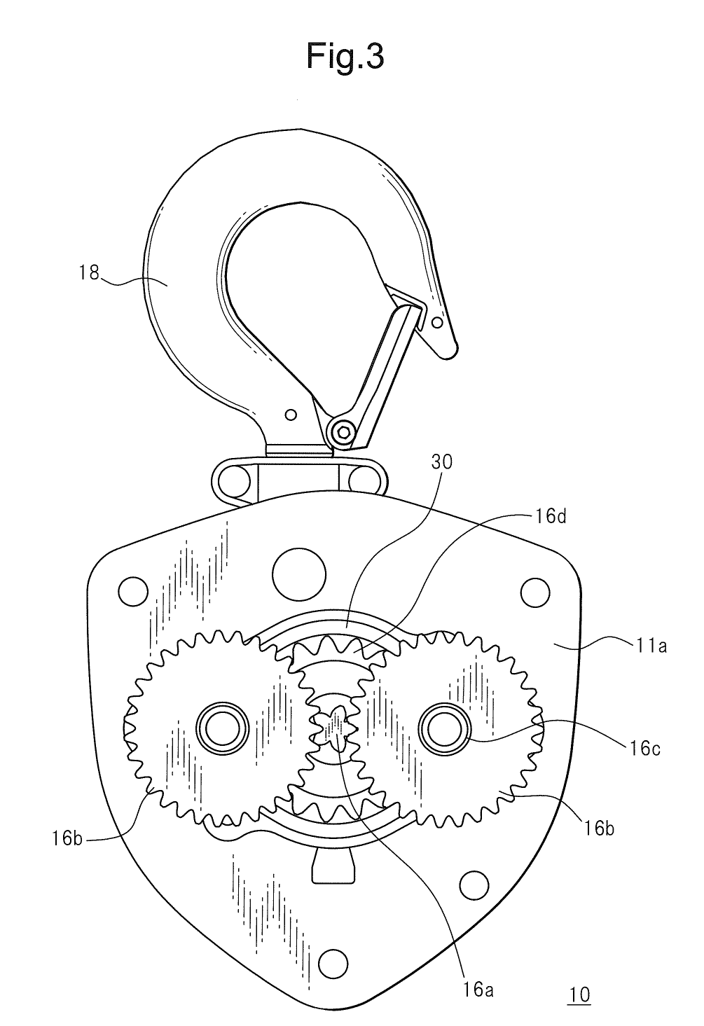

Referring also to FIG. 3, the reduction gear mechanism 16 has a pinion gear 16a provided on the drive shaft 15, and a pair of first reduction gears 16b and 16b which mesh with the pinion gear 16a.

The pinion gear 16a is a small gear having a toothed portion at the axial end of the drive shaft 15. The drive shaft 15 has a flange portion 15a adjacent to the pinion gear 16a and the flange portion 15a has a larger diameter as compared to the diameter of the shaft. A washer W is situated between the flange portion 15a and a portion projecting from the shaft portion 12a of the load sheave 12 to function as a stopper in a thrust direction.

The pinion gear 16a meshes with the pair of the first reduction gears 16b and 16b, respectively, at a first stage of predetermined reduction ratio. The pair of the first reduction gears 16b and 16b are opposed to each other in a horizontal direction with the pinion gear 16a positioned at their center. In this case, as will be described below, the shaft portions of the pair of the first reduction gears 16b and 16b are supported by an end face of the gear cover Gc opposed to the axial end of the drive shaft 15 and by an auxiliary plate mounted onto the first main frame 11a, which will be described below.

Referring to FIG. 2, the reduction gear mechanism 16 has a pair of second reduction gears 16c and 16c provided on the shaft portions of the pair of the first reduction gears 16b, 16b, and a load gear 16d which meshes with the pair of the second reduction gears 16c and 16c at a second stage of predetermined reduction ratio.

The load gear 16d is fitted onto the outer circumferential surface of the shaft portion 12a of the load sheave 12, and is held by means of a spline connection. The load gear 16d has a recess 16e in the center of the left end side thereof. The flange portion 15a is situated in the recess 16e and the end face of the load gear 16d on the left side is made flush with the flange portion 15a. A boss portion 16f is situated in the center of the load gear 16d on the opposite side of the recess 16e and bulges toward the bearing 13a. The boss portion 16f has a smaller diameter than the outer diameter of the load gear 16d. The boss portion 16f is inserted to a center hole 32 of an auxiliary plate 30, which will be described below, so as to extend in the center hole 32. The load gear 16d is positioned by a stepped portion of the shaft portion 12a.

The auxiliary plate 30 is situated in the circumference of the bearing 13a of the first main frame 11a for supporting the shaft portion 12a of the load sheave 12. The auxiliary plate 30 is provided so as to be mounted on the side surface of the first main frame 11a. The auxiliary plate 30 is processed so as to be plastically deformed and form a stepped portion in a thrust direction.

In order to prepare the auxiliary plate 30, a draw portion 31 is formed by means of drawing, for example, such that its center portion is spaced apart from the end surface of the first main frame 11a over a predetermined distance. Then, the draw portion 31 is perforated, with the draw portion 31 as the center, to form a center hole 32 to which the bearing 13a can be fitted with the outer circumference of the bearing 13a in contact therewith.

The bearings 13a and 13b for rotatably supporting the load sheave 12 via the shaft portions 12a and 12b abut to a projecting portion of the load sheave 12 which projects in the form of a flange inside the opposing first and second main frames 11a and 11b. A stop ring 13r is provided on the bearings 13a and 13b in order to hold the bearings 13a and 13b against force applied by the load sheave 12 in a thrust direction.

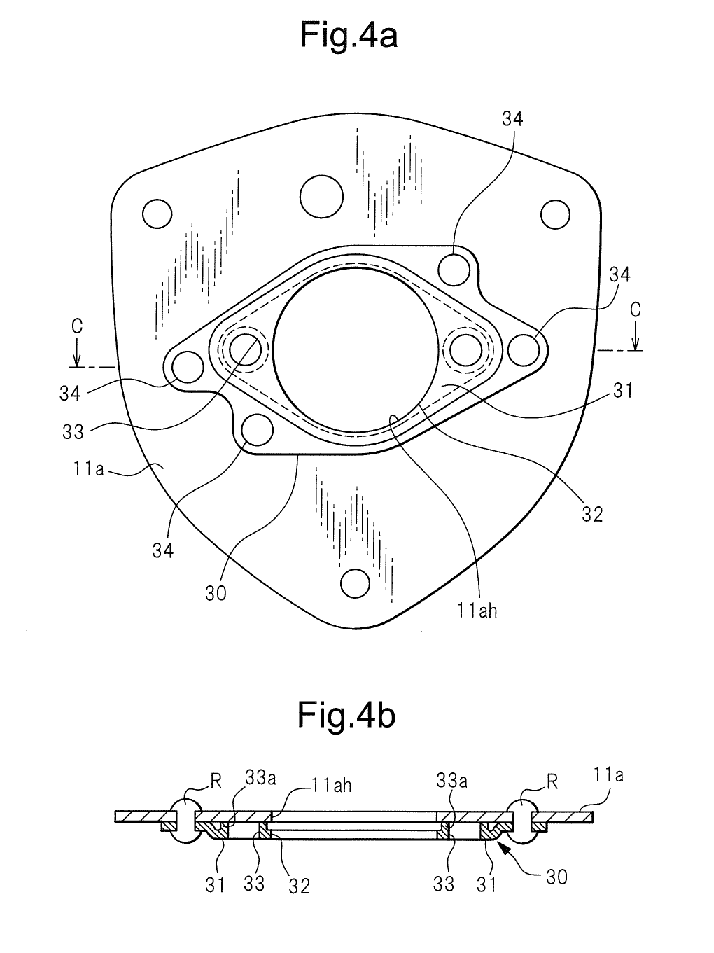

With also reference to FIGS. 4a and 4b, the auxiliary plate 30 mounted to the first main frame 11a will be described in detail below.

The first main frame 11a has an insertion hole 11ah through which the shaft portion 12a of the load sheave 12 is inserted via the bearing 13a. The auxiliary plate 30 is positioned by means of a shaft-like positioning jig fitted to the center hole 32 and the insertion hole 11ah such that a center of the center hole 32 of the auxiliary plate 30 coincides with that of the insertion hole 11ah. The auxiliary plate 30 is fixed to the first main frame 11a by means of rivets R.

Therefore, if the positioning jig has such a shaft diameter portion fitted to the center hole 32 and the insertion hole 11ah, the center hole 32 needs not coincide with the insertion hole 11ah. Yet if the center hole 32 coincides with the insertion hole 11ah as shown in FIGS. 1 and 2, it is easy to position the center hole 32 and the insertion hole 11ah relative to each other, and the center hole 32 and the insertion hole 11ah can be spaced apart to support the outer circumference of the bearing 13a over a greater area. As a result, the bearing 13a can be firmly supported.

Accordingly, the auxiliary plate 30 is provided with the draw portion 31 formed by means of drawing, for example, so as to separate a center portion of a steel plate material from the end surface of the first main frame 11a over a predetermined distance, as described above. The draw portion 31 has a bottom generally having a flat rhombus shape with rounded corners. Thereafter, the draw portion 31 is perforated at its center to form the center hole 32. Bearing holes 33 for the shaft portions 16br of the first reduction gears 16b are simultaneously formed by means of burring, for example, on both sides with the center hole 32 interposed therebetween. The bearing holes 33 are formed at equal distance from the center of the center hole 32 and on the longer diagonal line of the bottom rhombus of the draw portion 31. Further, two or more fixing holes 34 are formed near the outer edge of the draw portion 31 in order to fix the auxiliary plate 30 to the first main frame 11a with the rivets R.

The center of the auxiliary plate 30 is positioned relative to the first main frame 11a by means of the center hole 32 and the insertion hole 11ah. The auxiliary plate 30 has an embossed portion (half punched portion, not shown) in the vicinity of the fixing hole 34, and the embossed portion can be fitted to a positioning hole (not shown) of the first main frame 11a for positioning the center hole 32 in the circumferential direction. With the aid of the positioning hole and the embossed portion, the auxiliary plate 30 is positioned and fixed to the first main frame 11a with the rivets R. Tubular portions 33a of the bearing holes 33 of the auxiliary plate 30 are preferably held in close contact with the first main frame 11a.

The auxiliary plate 30 as described above is subjected to predetermined heat treatment (hardening or the like) before fixed to the first main frame 11a. The auxiliary plate 30 serves as a bearing by being fixed to the first main frame 11a, while it also serves as an enforcing member for preventing the first main frame 11a from being deformed in the thrust direction by means of the draw portion 31.

The axial end of the left end side of the first reduction gear 16b is supported by the bearing hole 35 formed, by means of burring, at a portion of the gear cover Gc opposed to the axial end of the drive shaft 15. A cover end plate Ct is attached to the outer side of the bearing hole 35, and certain grease is filled in the inner space of the gear cover Gc to ensure lubrication of each gear and bearing.

The configuration of the manual chain block 10 according to the first embodiment has been described above. An operation and function of the manual chain block 10 will be now described.

When the hand wheel 20 undergoes positive rotation as the hand chain (not shown) is operated, the drive member 19g of the hand wheel 20 is moved on the multiple thread of the drive shaft 15 to come in contact with the brake member 19b of the mechanical brake 19 and tighten the brake member 19 and the like. As a result, the driven member 19a and the drive shaft 15 are coupled together so that mechanical power is transmitted therebetween, and rotational force of the hand wheel 20 is transmitted to the drive shaft 15.

On the other hand, when the hand wheel 20 undergoes rotation in a direction opposite to the above-described rotation, the drive member 19g of the hand wheel 20 is moved on the multiple thread of the drive shaft 15 away from the brake member 19b of the mechanical brake 19. As a result, the braking action of the mechanical brake 19 is terminated, and the drive shaft 15 is then able to rotate together with the hand wheel 20 in the direction to wind down. The load chain looped around the load sheave 12 is simultaneously wound down and a lower hook (not shown) for hanging a load can be lowered to the position of the load.

When the load is hooked to the lower hook and the hand wheel 20 undergoes positive rotation, the drive member 19g of the hand wheel 20 is moved on the multiple thread of the drive shaft 15 to come in contact with the brake member 19b of the mechanical brake 19 and tighten the brake member 19b and the like. As a result, the driven member 19a and the drive shaft 15 are coupled together so that mechanical power is transmitted therebetween, and rotational force of the hand wheel 20 is transmitted to the drive shaft 15. Accordingly, the load sheave 12 is rotated via the reduction gear mechanism 16 at a predetermined speed reduction ratio so as to wind the load up by the load chain.

When rotational force of the hand wheel 20 is transmitted to the drive shaft 15, the rotational force is transmitted at a predetermined first speed reduction ratio from the pinion gear 16a at the axial end of the drive shaft 15 to the pair of the first reduction gears 16b and 16b opposed to each other in a horizontal direction with the pinion gear 16a situated as a center thereof.

The pair of the first reduction gears 16b and 16b can be rotated with the bearing hole 35 of the gear cover Gc functioning as a bearing for the axial end on the left end side and with the bearing hole 33 near the center hole 32 of the auxiliary plate 30 functioning as a bearing on the right end side of the shaft portion 16br.

The rotational force transmitted through the first stage of reduction ratio is transmitted to the load gear 16d at a second stage of reduction ratio through the second reduction gear 16c integrally formed on the shaft portion of the first reduction gears 16b and 16b. The rotational force is then transmitted to the load sheave 12 which is in a spline connection with the load gear 16d. In this way, the load gear 16d and the load sheave 12 are rotated together.

As described above, the lateral surface of the toothed portion of the reduction gear 16c is opposed to the draw portion 31 of the auxiliary plate 30 mounted around the bearing 13a, so as to come into contact with the draw portion 31. As a result, force of the reduction gear 16c in a thrust direction and a radial direction produced when the reduction gear 16c is rotated together with the load sheave 12 is borne by the draw portion 31 of the auxiliary plate 30.

The draw portion 31 of the auxiliary plate 30 is formed so as to be spaced apart from the end surface of the first main frame 11a over a predetermined distance. Further, the auxiliary plate 30 has been subjected to certain heat treatment. In addition, the tubular portion 33a of the bearing hole 33 of the auxiliary plate 30 is held in close contact with the first main frame 11a. In this way, the force of the reduction gear 16c in a thrust direction is borne by the first main frame 11a via the tubular portion 33a, and therefore, the auxiliary plate 30 can be reduced in wall thickness.

As described above, in the manual chain block 10, in order to provide the pair of the first reduction gears 16b and 16b that may give rise to a problem relating to a space in the reduction gear mechanism 16, the bearing holes 35 and 33 obtained by processing the gear cover Gc and the auxiliary plate can be used as bearings in place of ordinary bearings.

Specifically, since the bearing hole 33 of the auxiliary plate 30 is formed in the proximity of the center hole 32 and adjacent to the bearing 13a for supporting the shaft portion 12a of the load sheave 12, the shaft of the reduction gear can be positioned as close to the center as possible. Such a configuration contributes to miniaturization of the manual chain block 10.

In addition, the auxiliary plate 30 is held in close contact with the first main frame 11a via the tubular portion 33a of the bearing hole 33 with the center hole 32 of the draw portion 31 interposed therebetween, and therefore, the first main frame 11a and the auxiliary plate 30 form the composite structure. As a result, force is exerted on the load sheave 12 and the reduction gear in a distributed manner, so that the first main frame 11a and the auxiliary plate 30 can be made in reduced thickness.

### Second Embodiment

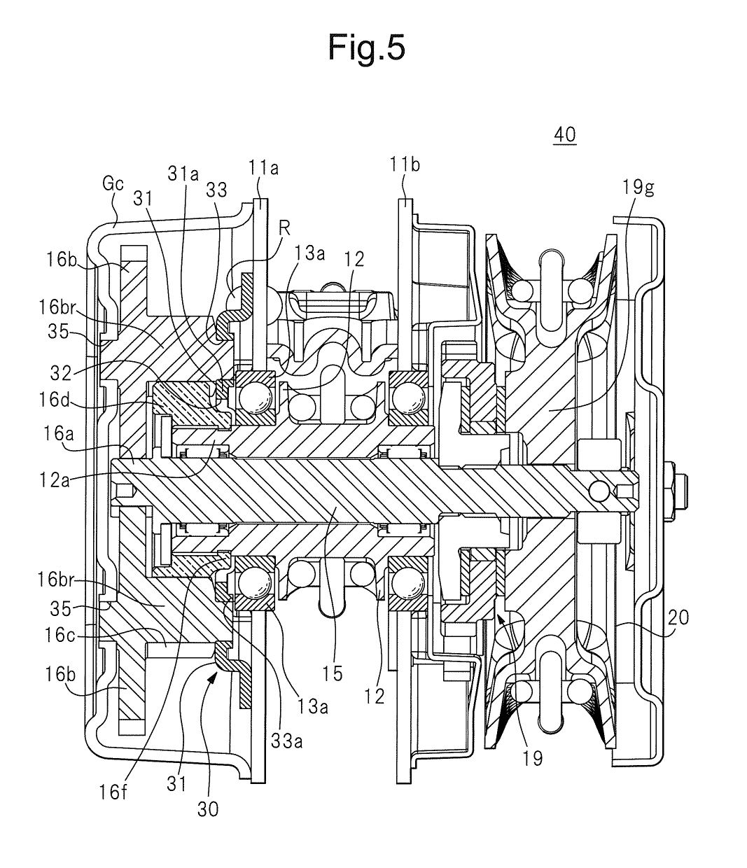

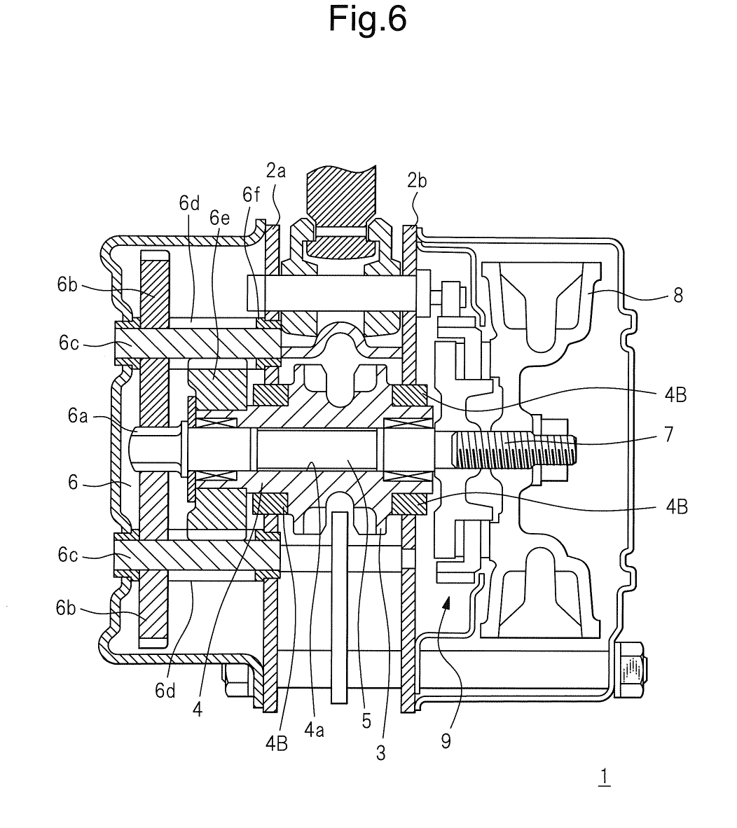

FIG. 5 shows a manual chain block 40 according to a second embodiment. The manual chain block 40 according to the present embodiment basically has a configuration similar to that of the manual chain block 10 according to the first embodiment. Accordingly, substantially the same elements are denoted by the same reference numerals, and explanation thereon will be omitted.

In this manual chain block 40, in order to allow the shaft of the reduction gears to be located close to the center, or in order to allow a bearing (ball bearing) 13a having a large diameter to be used, the auxiliary plate 30 is not situated around the outer periphery of the bearing 13a for supporting the shaft portion 12a of the load sheave 12, but extends between the toothed portion of the load gear 16d and the bearing 13a, and therefore closer to the shaft portion 12a of the load sheave 12.

In the manual chain block 40, too, the axial end on the left end side of the first reduction gear 16b of the reduction gear mechanism 16 is rotatably supported in the bearing hole 35 formed in the gear cover Gc, while the right end side of the shaft portion 16br is rotatably supported in the bearing hole 33 of the auxiliary plate 30.

In this case, the bearing hole 33 of the auxiliary plate 30 is close to the bearing 13a of the first main frame 11a in the radial direction, and the tubular portion 33a of the bearing hole 33 situated near the center is positioned so as to come in contact with the side surface of the bearing 13a.

With the above configuration and arrangement, force in a thrust direction exerted onto the bearing 13a for supporting the shaft portion 12a of the load sheave 12 can be borne by the tubular portion 33a of the bearing hole 33 of the auxiliary plate 30 situated closer to the center.

If the outer diameter of the bearing 13a is smaller relative to the position where the tubular portion 33a is provided, a bottom annular portion 31a of the draw portion 31 around the inner periphery of the center hole 32, rather than the tubular portion 33a, may also come in contact with the side surface of the bearing 13a.

In accordance with the manual chain block 40 as described above, not only can the shaft of the reduction gear be positioned closer to the center, but also the force in a thrust direction exerted onto the bearing 13a for supporting the shaft portion 12a of the load sheave 12 can be borne by the tubular portion 33a of the bearing hole 33 of the auxiliary plate 30 situated closer to the center, or by the annular portion 31a around the inner periphery of the center hole 32.

Also, the force exerted from the load sheave 12 onto the bearing 13a in a thrust direction can be borne by the portion of the auxiliary plate 30 extending between the toothed portion of the load gear 16d of the auxiliary plate 30 and the bearing 13a. Accordingly, the stop ring 13r provided on the bearing 13a for supporting force exerted from the load sheave 12 in a thrust direction can be dispensed with.

Although the present invention has been described above with reference to particular embodiments, it will be apparent to those skilled in the art that various modifications or alterations can be made without departing from the scope and spirit of the invention.

### LIST OF REFERENTIAL NUMERALS

10 manual chain block
11a first main frame
11ah insertion hole
11b second main frame
12 load sheave
12a, 12b shaft portion
12c through hole
13a, 13b bearing
13r stop ring
14a, 14b needle bearing
15 drive shaft
15a flange portion
16 reduction gear mechanism
16a pinion gear
16b first reduction gear
16br shaft portion 16c second reduction gear
16d load gear
16f boss portion
17 stud bolt
18 upper hook
19 mechanical brake
19a driven member
19b brake member
19c bush
19d ratchet gear
19e torsion spring
19f claw member
20 hand wheel
30 auxiliary plate
31 draw portion
31a bottom annular portion
32 center hole
33 bearing hole
33a tubular portion
34 fixing hole
35 bearing hole
40 manual chain block
Gc gear cover
Hc wheel cover
W washer
R rivet
Ct cover end plate

What is claimed is:

1. A manual chain block comprising:
a drive shaft capable of rotating in response to a manual operational force; and
a load sheave around which a load chain is looped, the load sheave being mounted coaxially to the drive shaft, supported together with the drive shaft on a frame via a bearing and coupled to the drive shaft so that mechanical power is transmitted therebetween, via a reduction gear mechanism, wherein
the reduction gear mechanism includes a pinion gear provided on the drive shaft, reduction gears which mesh with the pinion gear, and a load gear which is interlocked with the load sheave and meshes with the reduction gears, and wherein
the manual chain block further comprises an auxiliary plate mounted on a side surface of the frame and in the periphery of the bearing, the auxiliary plate including a stepped portion formed in a thrust direction of the bearing and having a bearing hole which serves as a bearing for the reduction gear.

2. The manual chain block according to claim 1, wherein the auxiliary plate includes:
a draw portion formed by drawing so as to be spaced apart over a predetermined distance from a surface of the frame on which the auxiliary plate is mounted,
a center hole formed in a center of the draw portion, and
a bearing hole formed in the vicinity of the center hole and projecting toward the surface of the frame on which the auxiliary plate is mounted, so as to serve as a bearing for the reduction gear.

3. The manual chain block according to claim 2, wherein the bearing hole is formed in a tubular portion projecting toward the frame by means of burring.

4. The manual chain block according to claim 3, further comprising a fixing hole for fixing the auxiliary plate by means of a rivet, the fixing hole being formed in the auxiliary plate in the vicinity of an outside of an outer edge of the draw portion.

5. The manual chain block according to claim 3, wherein the tubular portion of the bearing hole of the auxiliary plate situated closer to the center hole is positioned so as to come in contact with a side surface of the bearing.
